(19) United States
(12) Patent Application Publication
(10) Pub. No.: US 2004/0153700 A1
(43) Pub. Date: Aug. 5, 2004

(54) Redundant application stations for process control systems

(76) Inventors: Mark J. Nixon, Round Rock, TX (US); Ken Beoughter, Round Rock, TX (US)

Correspondence Address: GROSSMAN & FLIGHT LLC, Suite 4220, 20 North Wacker Drive, Chicago, IL, 60606-6357, US

(21) Appl. No.: 10/335,289

(22) Filed: Jan. 2, 2003

(51) Int. Cl. H04L 1/22

(52) U.S. Cl. 714/4

(57) ABSTRACT

An application station for use in a process control system includes a redundancy manager and a redundancy link subsystem coupled to the redundancy manager. The redundancy manager is adapted to communicate with a second application station via a redundancy communication link. The redundancy manager establishes a redundancy context with the second application station and uses the redundancy context to track the operations of the second application station. Additionally, the redundancy manager receives information from the second application station via the redundancy link and the redundancy link subsystem and, in response to the information, executes a switchover of the operations of the second application station to the application station.

### FIELD OF THE DISCLOSURE

The present invention relates generally to process control systems and, more specifically, to redundant application stations for use in process control systems.

### BACKGROUND

Process control systems, like those used in chemical, petroleum or other processes, typically include one or more centralized process controllers communicatively coupled to at least one host or operator workstation and to one or more field devices via analog, digital or combined analog/digital buses. The field devices, which may be, for example valves, valve positioners, switches and transmitters (e.g., temperature, pressure and flow rate sensors), perform functions within the process such as opening or closing valves and measuring process parameters. The process controller receives signals indicative of process measurements made by the field devices and/or other information pertaining to the field devices, uses this information to implement a control routine and then generates control signals that are sent over the buses or other communication lines to the field devices to control the operation of the process. Information from the field devices and the controllers may be made available to one or more applications executed by the operator workstation to enable an operator to perform desired functions with respect to the process, such as viewing the current state of the process, modifying the operation of the process, etc.

Many process control systems also include one or more application stations. Typically, these application stations are implemented using a personal computer, workstation, or the like that is communicatively coupled to the controllers, operator workstations, and other systems within the process control system via a local area network (LAN). Each application station may execute one or more software applications that perform campaign management functions, maintenance management functions, virtual control functions, diagnostic functions, real-time monitoring functions, etc. within the process control system.

An application station failure due to, for example, a software failure or a hardware failure (e.g., a loss of network communications, a loss of power, etc.) within the application station and/or elsewhere within the process control system, typically results in termination of the functions and applications performed by the failing or failed application station. Some process control systems or application stations are configured to provide limited application station recovery capabilities. For example, some known application stations store configuration information, control parameters and values, historical data, etc. associated with the functions and/or application(s) that it executes. This stored historical information or data may be used by the process control system following a restart (e.g., a reboot) of an application station to recover an application that has terminated, locked-up or that has otherwise become inoperative as a result of a hardware and/or software error or failure.

Unfortunately, known application station recovery techniques are essentially cold restarts or reboots of the application station followed by a time consuming data restoration process and a non-synchronized re-instantiation of the software application(s) executed by the application station. While these known application station recovery techniques may be suitable for some process control applications, they are not suitable for all process control applications and, in some cases, may lead to dangerous and/or costly consequences. In particular, known application station recovery techniques are not seamless or “bumpless” because they typically involve a substantial time delay between failure of the application station and its recovery. Thus, the historical parameter values stored prior to a failure may no longer be suitable due to changes in the equipment or other process conditions that occur during the relatively lengthy recovery period. In some cases, the use of such historical parameter values may be very costly and/or dangerous. For example, in the case of virtual control and campaign management applications, the use of inappropriate parameter values may result in lost batches, damage to people and/or equipment, etc. Furthermore, in the case where an application station failure is a result of a non-recoverable hardware failure, the application will be terminated until the hardware is replaced or repaired, which may be an unacceptably long period of time.

### SUMMARY

In accordance with one aspect, an application station for use in a process control system includes a redundancy manager and a redundancy link subsystem coupled to the redundancy manger and adapted to communicate with a second application station via a redundancy communication link. The redundancy manager may establish a redundancy context with the second application station and may use the redundancy context to track the operations of the second application station. Additionally, the redundancy manager may be adapted to receive information from the second application station via the redundancy link and the redundancy link subsystem and, in response to the information, to switchover operations of the second application station to the application station.

In accordance with another aspect, a redundancy manager for use in an application station includes a heartbeat manager, an application programming interface and a resource monitor communicatively coupled to the heartbeat manager and the application programming interface. The heartbeat manager may monitor operational status information received from an application station.

In accordance with yet another aspect, a system and method for establishing a redundancy context within a process control system having first and second application stations downloads a configuration associated with the first application station to the second application station, determines that the first application station provides a sufficient quality of service and sends information pertaining to a set of resources used by the first application station to the second application station. In addition, the system and method may determine that the second application station has access to the set of resources used by the first application station and may establish the redundancy context within the process control system in response to a determination that the second application station has access to the set of resources used by the first application station.

### BRIEF DESCRIPTION OF THE DRAWINGS

FIG. 1 is a block diagram of an example process control system that uses the redundant application station apparatus and methods described herein;

FIG. 2 is a more detailed block diagram of an example manner in which the redundant application stations shown in FIG. 1 may be implemented; and

FIG. 3 is a more detailed block diagram of an example manner in which the redundancy managers shown in FIG. 2 may be implemented.

### DETAILED DESCRIPTION

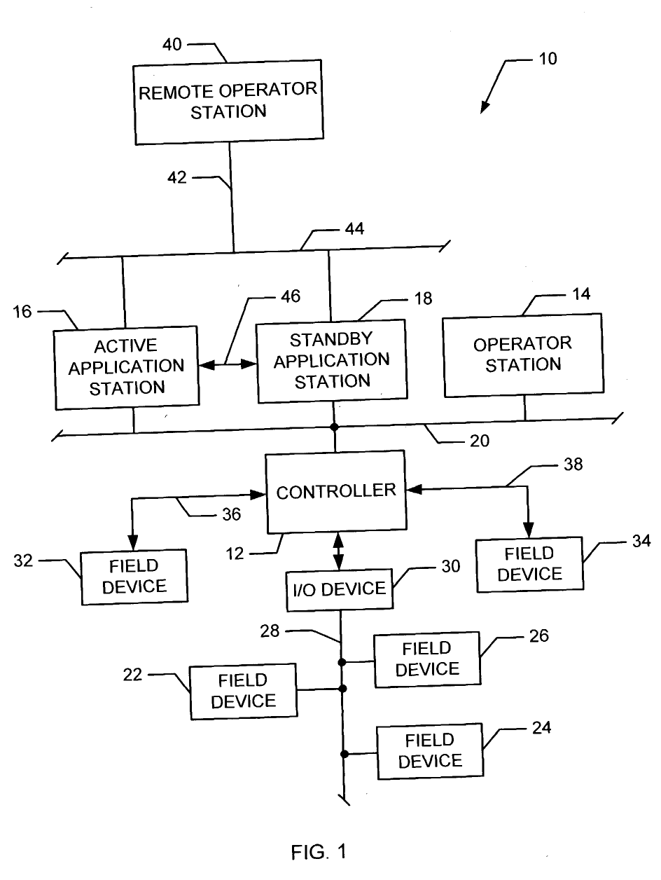

FIG. 1 is a block diagram of an example process control system 10 that uses the redundant application station apparatus and methods described herein. As shown in FIG. 1, the process control system 10 includes a controller 12, an operator station 14, an active application station 16 and a standby application station 18, all of which may be communicatively coupled via a bus or local area network (LAN) 20, which is commonly referred to as an application control network (ACN). The operator station 14 and the application stations 16 and 18 may be implemented using one or more workstations or any other suitable computer systems or processing units. For example, the application stations 16 and 18 could be implemented using single processor personal computers, single or multi-processor workstations, etc. In addition, the LAN 20 may be implemented using any desired communication medium and protocol. For example, the LAN 20 may be based on a hardwired or wireless Ethernet communication scheme, which is well known and, thus, is not described in greater detail herein. However, as will be readily appreciated by those having ordinary skill in the art, any other suitable communication medium and protocol could be used. Further, although a single LAN is shown, more than one LAN and appropriate communication hardware within the application stations 16 and 18 may be used to provide redundant communication paths between the application stations 16 and 18.

The controller 12 may be coupled to a plurality of smart field devices 22, 24 and 26 via a digital data bus 28 and an input/output (I/O) device 30. The smart field devices 22-26 may be Fieldbus compliant valves, actuators, sensors, etc., in which case the smart field devices 22-26 communicate via the digital data bus 28 using the well-known Fieldbus protocol. Of course, other types of smart field devices and communication protocols could be used instead. For example, the smart field devices 22-26 could instead be Profibus or HART compliant devices that communicate via the data bus 28 using the well-known Profibus and HART communication protocols. Additional I/O devices (similar or identical to the I/O device 30) may be coupled to the controller 12 to enable additional groups of smart field devices, which may be Fieldbus devices, HART devices, etc., to communicate with the controller 12.

In addition to the smart field devices 22-26, one or more non-smart field devices 32 and 34 may be communicatively coupled to the controller 12. The non-smart field devices 32 and 34 may be, for example, conventional 4-20 milliamp (mA) or 0-10 volts direct current (VDC) devices that communicate with the controller 12 via respective hardwired links 36 and 38.

The controller 12 may be, for example, a DeltaV™ controller sold by Fisher-Rosemount Systems, Inc. However, any other controller could be used instead. Further, while only one controller in shown in FIG. 1, additional controllers of any desired type or combination of types could be coupled to the LAN 20. In any case, the controller 12 may perform one or more process control routines associated with the process control system 10 that have been generated by a system engineer or other system operator using the operator station 14 and which have been downloaded to and instantiated in the controller 12.

As depicted in FIG. 1, the process control system 10 may also include a remote operator station 40 that is communicatively coupled via a communication link 42 and a LAN 44 to the application stations 16 and 18. The remote operator station 40 may be geographically remotely located, in which case the communication link 42 is preferably, but not necessarily, a wireless communication link, an internet-based or other switched packet-based communication network, telephone lines (e.g., digital subscriber lines), or any combination thereof.

As depicted in the example of FIG. 1, the active application station 16 and the standby application station 18 are communicatively coupled via the LAN 20 and via a redundancy link 46. The redundancy link 46 may be a separate, dedicated (i.e., not shared) communication link between the active application station 16 and the standby application station 18. The redundancy link 46 may be implemented using, for example, a dedicated Ethernet link (e.g., dedicated Ethernet cards in each of the application stations 16 and 18 that are coupled to each other). However, in other examples, the redundancy link 46 could be implemented using the LAN 20 or a redundant LAN (not shown), neither of which is necessarily dedicated, that is communicatively coupled to the application stations 16 and 18.

Generally speaking, the application stations 16 and 18 continuously, by exception, or periodically exchange information (e.g., in response to parameter value changes, application station configuration changes, etc.) via the redundancy link 46 to establish and maintain a redundancy context. The redundancy context enables a seamless or bumpless handoff or switchover of control between the active application station 16 and the standby application station 18. For example, the redundancy context enables a control handoff or switchover from the active application station 16 to the standby application station 18 to be made in response to a hardware or software failure within the active application station 16 or in response to a directive from a system user or system operator or a client application of the process control system 10.

In any event, the application stations 16 and 18 may appear as a single node on the LAN 20 that function as a redundant pair. In particular, the standby application station 18 functions as a “hot” standby application station that, in the event the active application station 16 fails or receives a switchover directive from a user, rapidly and seamlessly assumes and continues control of applications or functions being executed by the active application station 16, without requiring time consuming initialization or other user intervention. To implement such a “hot” standby scheme, the currently active application station (e.g., the active application station 16) uses the redundancy context to communicate information such as, for example, configuration information, control parameter information, etc. via the redundancy link 46 to its redundant partner application station (e.g., the standby application station 18). In this manner, a seamless or bumpless transfer of control or switchover from the currently active application station (e.g., the active application station 16) to its redundant partner or standby application station (e.g., the standby application station 18) can be made as long as the standby application station 18 is ready and able to assume control.

To ensure that the standby application station 18 is ready and able to assume control of applications, virtual control functions, communication functions, etc. currently being performed by the active application station 16, the redundancy context determines whether the standby application station 18 has access to the physical resources (e.g., the LAN 20, other external data sources, etc.), has the required programming information (e.g., configuration and connection information), and whether the required quality of service (e.g., processor speed, memory requirements, etc.) is available. Additionally, the redundancy context is maintained to ensure that the standby application station 18 is always ready to assume control. This redundancy context maintenance is carried out by conveying status information, configuration information or any other information, which is needed to maintain operational synchronization, between the redundant application stations 16 and 18.

In some examples, the application stations 16 and 18 may be configured so that in the event the active application station 16 fails and subsequently recovers to a healthy state or is repaired or replaced (and appropriately configured), the active application 16 regains control from the standby application station 18 and the standby application station 18 resumes its status as a hot standby station. However, if desired, the standby application station 18 may be configured to prevent a recovering application station from regaining control without system user approval or some other type of user intervention.

The active application station 16 is ordinarily responsible for carrying out (i.e., executing) virtual control functions, campaign management applications, maintenance management applications, diagnostic applications, and/or any other desired function or applications that may pertain to management and/or monitoring of process control activities, enterprise optimization activities, etc. needed within the process control system 10. The standby application station 18 is configured in an identical manner to the active application station 16 and, thus, includes a copy of each function and application that is needed for execution within the active application station 16. In addition, the standby application station 18 includes hardware and/or access to resources that are identical or at least functionally equivalent to the resources available to the active application station 16. Still further, the standby application station 18 tracks the operation of the active application station 16 (e.g., the current parameter values used by applications being executed within the active application station 16) via the redundancy link 46.

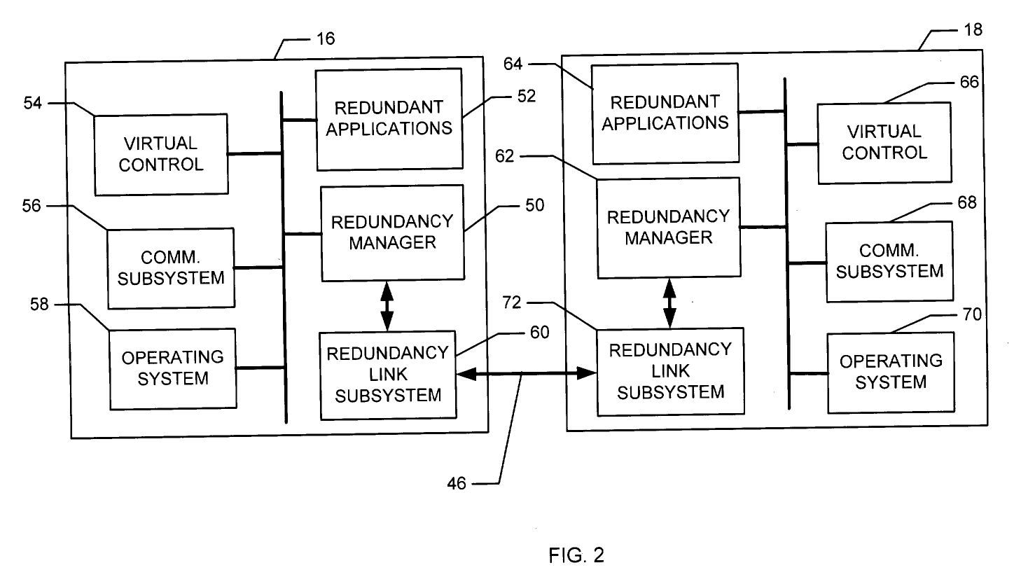

FIG. 2 is a more detailed block diagram of an example manner in which the redundant application stations 16 and 18 shown in FIG. 1 may be implemented. As depicted in the example of FIG. 2, the active application station 16 includes a redundancy manager 50 that is communicatively coupled to one or more redundant applications 52, a virtual control block 54, a communications subsystem 56, an operating system 58 and a redundancy link subsystem 60. Similarly, the standby application station 18 includes a redundancy manager 62, one or more redundant applications 64, a virtual control block 66, a communications subsystem 68, an operating system 70 and a redundancy link subsystem 72. While the functional blocks 62-72 shown in the standby application station 18 provide functionality that is identical or at least substantially identical to the functionality of respective functional blocks 50-60 in the active application station 16, different reference numerals have been used for corresponding functional blocks (e.g., blocks 50 and 62) to clarify the operational description of the application stations 16 and 18. In particular, although the corresponding functional blocks in the active application station 16 and the standby application station 18 may provide identical (or substantially identical) functionality, they are independently instantiated within their respective ones of the application stations 16 and 18 and, thus, are not necessarily in exactly the same operational state at the same instant of time.

In general, the functional blocks 50-60 and 62-72 interact in a cooperative manner with their respective redundancy managers 50 and 62 to establish and maintain a redundancy context. The redundancy context enables the standby application station 18 to track or shadow the operation of the active application station 16. More specifically, the application stations 16 and 18 exchange information via their respective redundancy link subsystems 60 and 72 and the redundancy link 46 so that each of the application stations 16 and 18 can determine the operational health (i.e., the operational status) of the other application station. In addition, operational parameter values and other information may be conveyed between the active application station 16 and the standby application station 18 via the redundancy link 46. The redundancy manager 62 of the standby application station 18 may convey the parameter information or values that it receives from the active application station 16 to one or more of the redundant applications 64, the virtual control block 66, the communications subsystem 68, and/or the operating system 70, etc. as needed to maintain an operational condition within the standby application station 18 that is substantially synchronized with and/or which shadows that of the active application station 16.

To better understand the interaction or cooperation between the redundancy managers 50 and 62 and their respective local subsystems or functional blocks 52-60 and 64-70, a more detailed explanation of the operation of the functional blocks 52-60 and 64-70 follows. The redundant applications 52 and 64 include one or more software applications such as, for example, campaign management applications, maintenance management applications, real-time monitoring applications, diagnostic applications, etc. The redundant applications 52 and 64 are typically, but not necessarily, layered software applications (i.e., software applications that are layered over other software applications). For example, a campaign management application is typically layered over one or more batch management applications.

The redundant applications 52 and 64 are registered with their respective redundancy managers 50 and 62 and, thus, are fully integrated within the redundancy context created and maintained by the redundancy managers 50 and 62. In other words, the redundant applications 52 and 64 can function as redundant pairs of applications so that if, for example, one of the redundant applications 52 fails, a corresponding identical partner application within the redundant applications 64 can, following a switchover from the active application station 16 to the standby application station 18, continue execution where the failed application left off.

To enable the redundant applications 52 and 64 to participate in the redundancy context, corresponding ones of the applications 52 and 64 exchange status and other information pertaining to the current state of the active application station 16, the standby application station 18 as well as the current state of the applications 52 and 64. In the event a switchover is initiated (e.g., the standby application station 18 assumes control for the active application station 16 in response to the failure of the active application station 16 or in response to a directive from a system user), the redundancy manager 62 may notify the redundant applications 64 that such a switchover is in progress. In turn, the standby application station 18 may generate one or more system alarms or events that may, for example, be communicated to and presented to a system user via one or both of the operator stations 14 and 40. Also, for example, in the case where the active application station 16 detects a failure of the standby application station 18, the redundant applications 52 will receive a notification of this condition and, if desired, one or more appropriate alarms or events may be generated by the active application station 16 and propagated to the operator stations 14 and 40 and/or to other systems coupled to the process control system 10. In any case, each of the applications within the redundant applications 52 and 64 is configured to respond to a notification that a switchover is in progress, a notification that the standby application station 18 has failed, etc. in an appropriate manner for that application.

The virtual control blocks 54 and 66 provide physical resource information to their respective redundancy managers 50 and 62 such as, for example, the amount of memory, processor speed, input/output information, etc., that is needed to perform virtual control functions. For example, the redundancy manager 62 may use the physical resource information to determine if the standby application station 18 has the capability (i.e., the appropriate physical resources) to takeover or assume control for the active application station 16 in the event a switchover is needed. In addition, the virtual control blocks 54 and 66 provide an indication to their respective redundancy managers 50 and 62 that the information they are using such as, for example, operating data, tuning data, etc. needs to be updated within its respective one of the application stations 16 and 18. In this manner, function block execution, sequencing, batch operations, etc. are fully synchronized. In the case where the virtual control blocks 54 and 66 enable system users, operators, third parties, etc. to generate custom function blocks, those custom function blocks will likewise be synchronized by the redundancy managers 50 and 62. Thus, the virtual control block 66 can track (i.e., is fully synchronized with) the operation of the virtual control block 54 so that in the event of a switchover from the active application station 16 to the standby application station 18, the virtual control block 66 can assume (i.e., takeover) the virtual control responsibilities of the virtual control block 54 in a seamless or bumpless manner. Preferably, the virtual control block 66 begins execution of its modules, methods, etc. with parameter values that are equal to the values of corresponding parameters within the virtual control block 54 at the switchover point.

Still further, the virtual control blocks 54 and 66 may be configured to provide an indication that a condition exists within one or both of the virtual control blocks 54 and 66 that should disable or prevent a switchover. For example, such an indication may be provided in the case where the configuration of the active application station 16 has changed and the standby application station 18 has not been updated, where an application (e.g., one of the redundant applications 64) within the standby application station 18 has failed, etc.

The communication subsystems 56 and 68 enable their respective application stations 16 and 18 and, thus, each of the functional blocks therein, to communicate via the LAN 20 to each other as well as other systems within the process control system 10. In addition, to enable and facilitate cooperation of the application stations 16 and 18 within the redundancy context established and maintained by the redundancy managers 50 and 62, the communications subsystems 56 and 68 provide services and/or information to their respective redundancy managers 50 and 62. In particular, the communications subsystems 56 and 68 may provide services such as, for example, a service that allows the communications subsystems 56 and 68 to be disabled, a service that verifies that the active application station 16 is coupled to the same LAN (i.e., the LAN 20) as the standby application station 18, a service that provides an indication that a communications subsystem has failed, and a service that, upon a switchover, enables the newly active application station (e.g., the standby application station 18) to assume the communication responsibilities of the now inactive application station (e.g., the active application station 16) on the LAN 20. For example, the newly active application station may re-establish the communication connections of the previously active application station with the other systems, devices, etc. via the LAN 20.

Each of the communications subsystems 56 and 68 may also provide an indication that the data it is managing (i.e., connection information, routing information, etc.) has changed and, thus, must be updated in the redundant partner application station. For example, the communications subsystem 56 of the active application station 16 may indicate to the standby application station 18 that a new connection has been established to the active application station 16. This new connection information may be conveyed by the redundancy manager 50 via the redundancy link subsystem 60, the redundancy link 46, and the redundancy link subsystem 72 to the redundancy manager 62. The redundancy manager 62 may then communicate with the communications subsystem 68 to establish the new connection to maintain the redundancy context. In this manner, the redundancy manager 62 maintains the standby application station 18 in a condition in which is it able to assume the communications responsibilities of the active application station 16 in the event of a switchover.

Each of the redundancy link subsystems 60 and 72 provides a service that enables its respective one of the application stations 16 and 18 to establish a communication channel or link via the redundancy link 46. In addition, the redundancy link subsystems 60 and 72 provide an indication to their respective redundancy managers 50 and 62 in the event the communication channel or link between the application stations 16 and 18 has failed. Further, the redundancy link subsystems 60 and 72 provide services that enable operational data associated with the redundant applications 52 and 64, the virtual control blocks 54 and 66, the communications subsystems 56 and 68, the operating systems 58 and 70, etc. to be exchanged between the application stations 16 and 18.

As described in greater detail below, the redundancy managers 50 and 62 use the information transmission capabilities of their redundancy link subsystems 60 and 72 and the redundancy link 46 to convey status information pertaining to monitored resources. Such status information may be conveyed in response to parameter value and/or configuration changes, etc. by, for example, the active application station 16 to the standby application station 18, to provide a “heartbeat” signal or information indicative of the health and/or operational status of the active application station 16. As a result, if the heartbeat signal indicates that the health of the active application station 16 is seriously impaired and/or if the heartbeat signal is completely absent, the standby application station 18 may initiate a switchover and assume control responsibility for the failed or failing active application station 16.

The operating systems 58 and 70 are any desired operating system such as, for example, Windows®, Linux®, etc. within which the runtime environment of the application stations 16 and 18 may be hosted. For the example process control system 10 shown in FIG. 1, the runtime environment may be a DeltaV™ runtime environment. The operating systems 58 and 70 may provide information to the redundancy manager 50 and 62 such as, for example, information pertaining to the status, health, capabilities, etc. of the hardware platform associated with the application stations 16 and 18. Of course, such information may vary based on the hardware used to implement the application stations 16 and 18. For example, in the case where the application stations 16 and 18 are implemented using multiprocessor workstations, one type of information may be provided, whereas, in the case where the application stations 16 and 18 are implemented using single processor personal computers, another type or quantity of information may be provided.

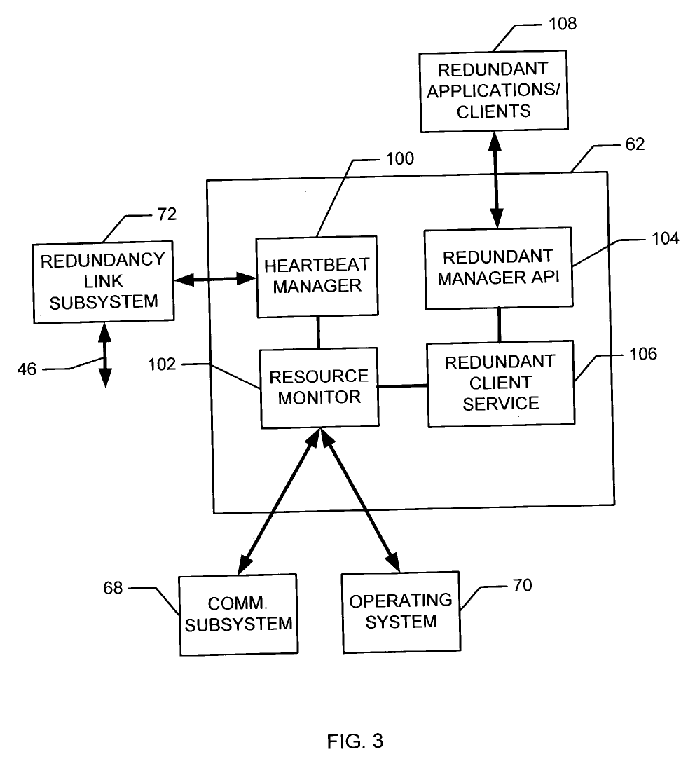

The redundancy managers 50 and 62 cooperatively communicate with their respective redundant applications 52 and 64, virtual control blocks 54 and 66, communications subsystems 56 and 68, operating systems 58 and 70, and redundancy link subsystems 60 and 72 to establish and maintain a redundancy context. In addition, the redundancy managers 50 and 62 manage the switchover between the application stations 16 and 18 either automatically upon a failure of the currently active application station or in response to a directive from a user. Still further, the redundancy managers 50 and 62 maintain diagnostic information pertaining to the redundancy context. For example, state information, data latency information, etc. may be maintained and, if desired, accessed and utilized by, for example, an optimization application and/or diagnostic application that is among the redundant applications 52 and 64, or which may be a client application in communication with the redundancy managers 50 and 62 in a manner described in greater detail in connection with FIG. 3 below.

FIG. 3 is a more detailed block diagram of an example manner in which the redundancy managers 50 and 62 shown in FIG. 2 may be implemented. For purposes of clarity, the example shown in FIG. 3 is described in detail as the redundancy manager 62 of the standby application station 18. However, the detailed block diagram of FIG. 3, and the following description thereof, is equally applicable to the redundancy manager 50 of the active application station 16. In any event, as shown in FIG. 3, the redundancy manager 62 includes a heartbeat manager 100, a resource monitor 102, a redundant manager application programming interface (API) 104 and a redundant client service 106.

The redundant manager API 104 enables one or more redundant applications or clients 108, which may include the redundant applications 64 shown in FIG. 2 as well as other applications or clients (which are not shown in FIG. 2), to participate in the redundancy context. In other words, the redundant manager API 104 contains functions that enable one or more of the applications or clients 108 to attach to (i.e., communicate with) the redundancy manager 62 to receive change of status events or information (e.g., switchover status of a given application station, parameter value or configuration changes, etc.). The change of status information or information conveyed by the redundancy manager 62 to the redundant applications/clients 108 may be derived from or based on information received by the heartbeat manager 100 from the redundancy link subsystem 72 and/or information that is received by the resource monitor 102 from one or more resources such as, for example, the communications subsystem 68 and the operating system 70.

The redundant manager API 104 implements an application registration function that enables an application or client within the redundant applications/clients 108 to communicate with the redundancy manager 62. The application registration function may generate a unique identifier for each registering application to enable the redundancy manager 62 to locate the application within the standby application station 18 when needed. In addition, the application registration function may include a callback function (which may be implemented using a helper thread) that enables the redundancy manager 62 to convey redundancy events (e.g., a switchover, a configuration change, etc.) to the registered application.

The redundant manager API 104 also implements an application de-registration function that removes a selected application from the list of registered applications. The application de-registration function is distinguishable from a failing application by the redundancy manager 62 and, thus, enables applications to be removed or de-registered without invoking an unnecessary switchover. For example, in the event that an application registered in the active application station 16 is de-registered, as opposed to failing, the standby application station 18 will not automatically invoke a switchover when its heartbeat manager 100 recognizes that the application has been purposefully de-registered and is no longer available.

The redundant manager API 104 also provides a forced switchover function that, when invoked by an application or client within the redundant applications/clients 108, causes the active application station 16 to switchover to the standby application station 18. Still further, the redundant manager API 104 provides a function that returns the current redundancy role of the redundancy manager 62 and, thus, the redundancy role of the application station within which the redundancy manager 62 resides, which in the example of FIG. 3 is the standby application station 18. Thus, when queried by one or more of the redundant applications/clients 108 using the redundancy role function, the redundant manager API 104 returns information indicating that the redundancy manager 62 and the application station 18 are operating in a standby role. If a similar query is made to a redundant manager API within the active application station 16, that redundant manager API would return information indicating an active role. Of course, any other desired function could be provided by the redundant manager API 104.

In operation, the redundancy managers 50 and 62 establish a redundancy context prior to allowing a switchover to be carried out. Initially, the application stations 16 and 18 are configured in an identical (or at least substantially identical) manner. Preferably, but not necessarily, the configuration of the active application station 16 is downloaded via the LAN 20 to, for example, the standby application station 18. A flag or other indicator may be set or configured within the standby application station 18 to designate that station as having a standby role. After the configuration of the active application station 16 has been downloaded to the standby application station 18, the standby application station 18 initiates communications with the active application station 16 via the redundancy link 46.

The standby application station 18 communicates with the active application station 16 via the redundancy link 46 to provide information to the active application station 16 about the quality of service that is required to establish the redundancy context. For example, the quality of service information may include a maximum permissible data latency parameter, a maximum permissible loss of control time, or any other parameter or value that may affect the performance, safety, costs, etc. associated with the process control system 10. If the active application station 16 cannot provide the required quality of service, the redundancy context will not be established.

The standby application station 18 may also query the active application station 16 to determine if the active application station 16 is already participating in a redundancy context with another application station. The redundancy context will not be established if the active application station 16 is already engaged as a member of a redundant pair of application stations.

If the active application station 16 is not already participating as a redundant partner to another application station (i.e., is already part of another redundancy context) and can provide the quality of service needed to support the redundancy context being established, the active application station 16 sends information pertaining to what resources are used to carry out the operations of the active application station 16. For example, the resource information exchanged between the standby application station 18 and the active application station 16 includes the memory requirements and processing unit class required to carry out the responsibilities of the active application station 16, proxy information (i.e., client and server) supported by the active application station 16, communications subsystem information (e.g., socket information, Internet protocol routing information, etc.).

After receiving the resource information, the standby application station 18 determines if it has access to the required resources and, if it does not have access to the required resources, the standby application station 18 returns an appropriate error indication to the active application station 16 and the redundancy context is not established. On the other hand, if the standby application station 18 has access to the required resources, the standby application station 18 establishes communications with the active application station 16, the communications subsystem 68, and any other subsystem or device to obtain the information from the resources needed to carry out the responsibilities of the active application station 16. Once the standby application station 18 has established the communications needed to obtain the required resource information, a flag or other indicator may be set to indicate that the redundancy context is established.

Once the redundancy context has been established between the active application station 16 and the standby application station 18, the context is maintained by communicating any configuration changes, operating parameter changes, communication subsystem changes, operator changes, sequencing information, batch phase information, alarm notifications, event information, resource locking information (e.g., acquiring a shared piece of equipment such as a header or reactor), etc. associated with the active application station 16 to the standby application station 18. For example, if a system user or operator changes the configuration of the active application station 16, those changes are communicated by the redundancy manager 50 via the redundancy link subsystems 60 and 72 and the redundancy link 46 to the redundancy manager 62. The redundancy manager 62 then updates the configuration of the standby application station 18 to match that of the active application station 16. Similarly, if parameter values such as, for example, tuning data, control loop parameters associated with the virtual control block 54, etc. change in a manner that affects the ability of the standby application station 18 to assume the control responsibilities of the active application station 16, these parameter values are communicated to and updated within the standby application station 18. Thus, operational changes in the active application station 16 are propagated to the standby application station so that the standby application station 18 is substantially synchronized with the operations of the active application station 16.

In the event that a configuration change is made to the active application station 16 and the change is propagated to the standby application station 18, the redundancy managers 50 and 62 disable automatic switchover (i.e., a switchover resulting from a failure in the active application station 16). While automatic switchover is disabled, the changed configuration information is conveyed via the redundancy link subsystems 60 and 72 and the redundancy link 46 to the standby application station 18. If the configuration information is successfully transferred and updated within the standby application station 18, automatic switchover is enabled. On the other hand, if the configuration information transfer and/or update fails, the redundancy context may be dissolved or terminated, in which case the application stations 16 and 18 no longer function as a redundant pair.

As noted above, a switchover may be initiated manually at the direction of a system user or operator or automatically in response to the detection of a condition or other event that requires the standby application station 18 to assume the responsibilities of the active application station 16. A manual switchover may be invoked by an authorized user by sending an appropriate function call to a redundant manager API, which may be similar to or identical to the redundant manager API 104, within the redundancy manager 50 of the active application station 16.

Automatic switchover is initiated by the standby application station 18 in response to a determination by the heartbeat manager 100 that the active application station 16 is no longer transmitting “heartbeats” (i.e., status information pertaining to monitored resources indicating that the active application station 16 is operationally healthy) via the redundancy link 46. Thus, the redundancy link subsystems 60 and 72 are configured to notify their respective redundancy managers 50 and 62 in the event that communications with a redundant context partner (e.g., the standby application station 18 is the redundant context partner of the active application station 16) are lost. Additionally, the communications subsystems 56 and 68 are configured to notify their respective redundancy managers 50 and 62 in the event that LAN communications with their respective ones of the application stations 16 and 18 have been lost. For example, if the active application station 16 experiences a communications failure on the LAN 20, the communications subsystem 56 notifies the redundancy manager 50 of the failure. The redundancy manager 50 then uses its redundancy link subsystem 60 to notify (via the redundancy link 46) the redundancy manager 62 within the standby application station 18 of the communication failure.

As noted above, a switchover may be invoked in response to a user's directive. In particular, a system user or operator may interact with one or more of the redundant applications/clients 108 (FIG. 3) via the redundant manager API 104 to call a function that invokes a switchover. Preferably, but not necessarily, the request for a switchover is sent to the redundancy manager 50 in the active application station 16. When the redundancy manager 50 receives the switchover request, the redundancy manager 50 informs the virtual control block 54 to switchover and any proxies supporting the active application station 16 are disabled. In addition, the resources supporting the active application station 16 are informed that a switchover has been initiated. For example, the communications subsystem 56 is notified that a switchover has been requested. In response to the switchover notification, the communications subsystem 56 ensures that the active application station 16 does not interfere with the standby application station 18 becoming active (i.e., assuming control). In addition, the communications subsystem 56 also ensures that all application station messages (e.g., operating change requests, tuning requests, etc.) are sent to the active application station 16.

After notifying the resources of the switchover, the redundancy manager 50 communicates via the redundancy link subsystems 60 and 72 and the redundancy link 46 to send a switchover command or request to the redundancy manager 62 in the standby application station 18. The standby application station 18 responds to the command or request to switchover by informing the virtual control block 66 to switchover and by enabling all proxies (which were previously disabled in the active application station 16) that are needed to support the virtual control block 66. The resources supporting the virtual control block 66 are then informed about the switchover. For example, the communications subsystem 68 is informed of the switchover in progress and may, in response, force Internet protocol routing information to be updated, may force re-establishment of TCP connections, etc. Of course, a switchover could instead be automatically initiated in response to a failure of the active application station 16.

The redundant application stations 16 and 18 may be used to carryout an on-line or “hot” configuration change of the active application 16. For example, after establishing a redundancy context between the active application station 16 and the standby application station 18, a switchover operation to switchover the operations of the active application station 16 to the standby application station 18 may be executed. The switchover operation or function is then temporarily disabled and the configuration of the active application station 16 may be changed in any desired manner. The configuration change may include an upgrade or change to one or more of the redundant applications 52, a change to the virtual control block 54, or any other desired change. The switchover operation or function is then re-enabled and a switchover operation to switchover the operations of the standby application station 18 to the active application station 16 is executed.

The functional blocks shown in the example application stations 16 and 18 may be implemented using any desired combination of software, firmware and hardware. For example, one or more microprocessors, microcontrollers, application specific integrated circuits (ASICs), etc. may access instructions or data stored on machine or processor accessible storage media to carry out the methods and to implement the apparatus described herein. The storage media may include any combination of devices and/or media such as, for example, solid state storage media including random access memory (RAM), read-only memory (ROM), electrically erasable programmable read-only memory (EEPROM), etc., optical storage media, magnetic storage media, etc. In addition, software used to implement the functional blocks may additionally or alternatively be delivered to and accessed by the processor or other device or devices executing the software via the Internet, telephone lines, satellite communications, etc.

Thus, while the present disclosure provides specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. An application station for use in a process control system, the application station comprising:
a redundancy manager; and
a redundancy link subsystem coupled to the redundancy manger and adapted to communicate with a second application station via a redundancy communication link.

2. An application station as defined in claim 1, wherein the redundancy manager establishes a redundancy context with the second application station.

3. An application station as defined in claim 2, wherein the redundancy manager maintains the redundancy context so that the operations of the application station track the operations of the second application station.

4. An application station as defined in claim 1, wherein the redundancy manager is adapted to receive information from the second application station via the redundancy link and the redundancy link subsystem and, in response to the information, to switchover operations of the second application station to the application station.

5. An application station as defined in claim 4, wherein the information received from the second application station includes monitored resource status.

6. An application station as defined in claim 4, wherein the information received from the second application station includes information indicative of the operational health of the second application station.

7. An application station as defined in claim 4, wherein the information received from the second application station includes one of failure information and information associated with a user directive to carryout a switchover.

8. An application station as defined in claim 4, wherein the operations of the second application station include virtual control operations.

9. An application station as defined in claim 4, wherein the operations of the second application station include redundant application operations.

10. An application station as defined in claim 4, wherein the operations of the second application station include network communications operations.

11. An application station as defined in claim 1, further including a redundant application that is communicatively coupled to the redundancy manager.

12. An application station as defined in claim 11, wherein the redundant application is a layered application.

13. An application station as defined in claim 1, further including a virtual control block that is communicatively coupled to the redundancy manager.

14. An application station as defined in claim 1, further including a communications subsystem that is communicatively coupled to the redundancy manager.

15. An application station as defined in claim 1, wherein the redundancy link subsystem is adapted to communicate via the redundant link using an Ethernet communication scheme.

16. A redundancy manager for use in an application station, comprising:
a heartbeat manager;
an application programming interface; and
a resource monitor communicatively coupled to the heartbeat manager and the application programming interface.

17. A redundancy manager as defined in claim 16, wherein the heartbeat manager monitors information received from an application station, and wherein the information is associated with the operational status of the application station.

18. A redundancy manager as defined in claim 16, wherein the application programming interface includes one of an application registration function, an application de-registration function and a directed switchover function.

19. A redundancy manager as defined in claim 16, wherein the application programming interface is adapted to interface a plurality of clients to the redundancy manager.

20. A redundancy manager as defined in claim 16, wherein the resource monitor is communicatively coupled to a plurality of application station resources.

21. A method of establishing a redundancy context within a process control system having first and second application stations, comprising:
downloading a configuration associated with the first application station to the second application station;
determining that the first application station provides a sufficient quality of service; and
sending information pertaining to a set of resources used by the first application station to the second application station;
determining that the second application station has access to the set of resources used by the first application station; and
establishing the redundancy context within the process control system in response to a determination that the second application station has access to the set of resources used by the first application station.

22. A method as defined in claim 21, wherein downloading the configuration associated with the first application station to the second application station includes conveying information via a process control network.

23. A method as defined in claim 21, wherein determining that the first application station provides a sufficient quality of service includes determining that the first application station provides at least the quality of service provided by the second application station.

24. A method as defined in claim 23, wherein determining that the first application station provides at least the quality of service provided by the second application station includes evaluating one of a maximum permissible data latency parameter and a maximum permissible loss of control time parameter.

25. A method as defined in claim 21, wherein determining that the first application station provides the sufficient quality of service includes determining a processor class and an amount of available memory.

26. A method as defined in claim 21, wherein sending information pertaining to the set of resources used by the first application station to the second application station includes sending one of control information and communications information.

27. A system for establishing a redundancy context within a process control system, comprising:
a first application station; and
a second application station communicatively coupled to the first application station, wherein the first application station is programmed to:
download a configuration to the second application station;
determine that the first application station provides a sufficient quality of service; and
send information pertaining to a set of resources used by the first application station to the second application station, and wherein the second application station is programmed to:
to determine that the second application station has access to the set of resources used by the first application station; and
establish the redundancy context within the process control system in response to a determination that the second application station has access to the set of resources used by the first application station.

28. A system as defined in claim 27, wherein the first application station is programmed to download the configuration to the second application station by conveying information via a process control network.

29. A system as defined in claim 27, wherein the first application station is programmed to determine that the first application station provides a sufficient quality of service by determining that the first application station provides at least the quality of service provided by the second application station.

30. A system as defined in claim 27, wherein the first application station is programmed to send the information pertaining to the set of resources used by the first application station to the second application station by sending one of control information and communications information.

31. A machine accessible medium having data stored thereon that, when executed, causes a machine to:
download a configuration associated with a first application station to a second application station;
determine that the first application station provides a sufficient quality of service;
send information pertaining to a set of resources used by the first application station to the second application station;
determine that the second application station has access to the set of resources used by the first application station; and
establish a redundancy context within a process control system in response to a determination that the second application station has access to the set of resources used by the first application station.

32. A machine accessible medium as defined in claim 31 having data stored thereon that, when executed, causes the machine to download the configuration associated with the first application station to the second application station by conveying information via a process control network.

33. A machine accessible medium as defined in claim 31 having data stored thereon that, when executed, causes the machine to determine that the first application station provides a sufficient quality of service by determining that the first application station provides at least the quality of service provided by the second application station.

34. A machine accessible medium as defined in claim 31 having data stored thereon that, when executed, causes the machine to send the information pertaining to the set of resources used by the first application station to the second application station by sending one of control information and communications information.

35. A method of maintaining a redundancy context in a process control system having first and second application stations, comprising:
communicating a change in a condition of the first application station to the second application station via a first redundancy manager and a redundancy link; and
updating information within the second application station based on the change in the condition via a second redundancy manager.

36. A method as defined in claim 35, wherein communicating the change in the condition of the first application station to the second application station via the first redundancy manager and the redundancy link includes communicating one of a configuration change, an operating parameter change, sequencing information, batch phase information, alarm information, event information and resource locking information.

37. A method as defined in claim 36, wherein communicating the change in the condition of the first application station to the second application station via the first redundancy manager and the redundancy link includes communicating information associated with a custom function block.

38. A method as defined in claim 35, wherein updating the information within the second application station based on the change in the condition via the second redundancy manager includes updating a redundant application within the second application station.

39. A method as defined in claim 35, wherein updating the information within the second application station based on the change in the condition via the second redundancy manager includes updating a virtual control block within the second application station.

40. A system for maintaining a redundancy context in a process control system, comprising:
a first application station; and
a second application station communicatively coupled to the first application station via a redundancy link, wherein the first application station is programmed to communicate a change in a condition of the first application station to the second application station via a first redundancy manager and the redundancy link, and wherein the second application station is programmed to update information within the second application station based on the change in the condition via a second redundancy manager.

41. A system as defined in claim 40, wherein the change in the condition of the first application station is one of a configuration change and an operating parameter change.

42. A system as defined in claim 40, wherein the second application station is programmed to update the information within the second application station based on the change in the condition via the second redundancy manager by updating a redundant application within the second application station.

43. A system as defined in claim 40, wherein the second application station is programmed to update the information within the second application station based on the change in the condition via the second redundancy manager by updating a virtual control block within the second application station.

44. A machine accessible medium having data stored thereon that, when executed, causes a machine to:
communicate a change in a condition of a first application station to a second application station via a first redundancy manager and a redundancy link; and
update information within the second application station based on the change in the condition via a second redundancy manager to maintain a redundancy context in a process control system.

45. A machine accessible medium as defined in claim 44 having data stored thereon that, when executed, causes the machine to communicate the change in the condition of the first application station to the second application station via the first redundancy manager and the redundancy link by communicating one of a configuration change and an operating parameter change.

46. A machine accessible medium as defined in claim 44 having data stored thereon that, when executed, causes the machine to update the information within the second application station based on the change in the condition via the second redundancy manager by updating a redundant application within the second application station.

47. A machine accessible medium as defined in claim 44 having data stored thereon that, when executed, causes the machine to update the information within the second application station based on the change in the condition via the second redundancy manager by updating a virtual control block within the second application station.

48. A redundant application station system, comprising:
a first application station having a first redundancy manager;
a second application station having a second redundancy manager; and
a redundancy link communicatively coupling the first and second redundancy managers.

49. A redundant application station system as defined in claim 48, wherein the first and second application stations are adapted to communicate status information via the redundancy link.

50. A redundant application station system as defined in claim 49, wherein the first and second application stations are adapted to maintain a redundancy context within a process control system based on the status information.

51. A redundant application station system as defined in claim 50, wherein the first and second application stations are adapted to enable the operations of the first application station to switchover to the second application station based on the status information.

52. A method of changing the configuration of an application station, comprising:
establishing a redundancy context between the application station and a standby application station;
executing a switchover operation to switchover the operations of the application station to the standby application station;
disabling the switchover operation;
changing the configuration information of the application station;
enabling the switchover operation; and
executing the switchover operation to switchover the operations of the standby application station to the application station.

53. A method as defined in claim 52, wherein changing the configuration information of the application station includes upgrading an application within the application station.

54. A method as defined in claim 53, wherein changing the configuration information of the application station includes upgrading a virtual control function with the application station.
